(19) United States
(12) Patent Application Publication
(10) Pub. No.: US 2005/0240449 A1
(43) Pub. Date: Oct. 27, 2005

(54) Method of managing a life insurance policy with a related medical scheme

(76) Inventors: Adrian Gore, Gauteng (ZA); Herschel Phillip Mayers, Johannesburg (ZA); Kenneth Steven Rabson, Johannesburg (ZA)

Correspondence Address: MARSHALL & MELHORN, FOUR SEAGATE, EIGHT FLOOR, TOLEDO, OH, 43604, US

(21) Appl. No.: 11/074,453

(22) Filed: Mar. 8, 2005

(30) Foreign Application Priority Data
Apr. 16, 2004 (ZA) 2004/2891

(51) Int. Cl. G06F 17/60

(52) U.S. Cl. 705/4

(57) ABSTRACT

A method of managing the business of a life insurance scheme of the kind in which a life insurer receives life insurance premiums from an insured life and pays a predetermined sum to the insured life on the occurrence of an insured event. The life insurance scheme is linked to a medical scheme of the kind in which the provider of such medical scheme undertakes liability in return for a premium or contribution, the insured life being a member of the medical scheme. A portion of the life insurance premiums paid by the insured life during a predetermined period are allocated to a fund according to predetermined criteria related to the status of the insured life with the medical scheme. An amount is deducted from the balance of the fund related to life insurance claims made by the member during the predetermined period and at predetermined intervals, the balance in the fund is paid to the insured life.

### BACKGROUND OF THE INVENTION

This invention relates to a method of managing a life insurance policy.

Conventionally, life insurance policies operate on the basis that an insured person, referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

In general, it would be beneficial both to the insured life and the life insurer if the insured life were to maintain his/her health and extend his/her life. It is an object of the invention to provide a method of managing a life insurance policy which addresses this goal.

### SUMMARY OF THE INVENTION

According to the invention there is provided a method of managing the business of a life insurance scheme of the kind in which a life insurer receives life insurance premiums from an insured life, the life insurer paying a predetermined sum assured to the insured life or a beneficiary nominated by the insured life on the occurrence of an insured event, the method comprising:
linking the life insurance scheme to a medical scheme of the kind in which the provider of such medical scheme undertakes liability in return for a premium or contribution, and provides to members who pay such premiums, or make such contributions, relevant health services and/or assistance in defraying expenses occurred in connection with rendering such relevant health services, the insured life being a member of the medical scheme;
allocating a portion of the life insurance premiums paid by the insured life during a predetermined period to a fund according to predetermined criteria related to the status of the insured life with the medical scheme during said predetermined period; and
at predetermined intervals, paying the balance in the fund to the insured life or a beneficiary nominated by the insured life.

The method may further include deducting from the balance of the fund an amount related to life insurance claims made by the member during the predetermined period

The predetermined criteria in terms of which a portion of the premiums paid by the insured life are allocated to the fund may include one or more of the following:
the specific medical plan chosen by the insured life;
the number of dependents of the insured life;
the level of claims made on the medical scheme by the insured life and his/her dependents during the predetermined period; and
the status of the insured life in a reward program associated with the medical plan.

The predetermined period is preferably at least one year and will typically be a five-year period.

The allocation of a portion of the premiums paid to the fund may be made annually.

The payment can be made into an account that the insured life has with a financial institution, for example. Alternatively, the payment could be made into another vehicle, such as into a medical savings account that the insured life has with the medical scheme or into a credit or debit card of the insured life, which credit or debit card is associated with the life scheme or medical scheme.

### DESCRIPTION OF AN EMBODIMENT

Conventional life insurance policies operate on the basis that an insured person, referred to as the insured life, pays premiums on a regular basis to the life insurer, specifying a sum assured which is an amount to be paid out on the occurrence of an insured event. For example, on the death of the insured life, a predetermined death benefit is paid to the nominated beneficiaries of the insured life. If the insured life is disabled or suffers a dread disease, a different, lesser amount is paid out.

Medical schemes (also referred to as medical aid schemes) exist in which the provider of the medical scheme undertakes liability in return for a premium or contribution paid by a member of the scheme. The provider of the medical scheme provides relevant health services or assists the member in defraying expenses incurred in connection with the rendering of such health services, according to a predetermined scale of benefits. Commonly, the medical scheme provider offers a number of different plans which provide greater or lesser benefits to members at correspondingly higher or lower costs.

Schemes exist which aim to encourage medical scheme members to use their benefits responsibly and which reward members for making use of health related services or facilities, and otherwise managing their health positively. An example of such a scheme is the “Vitality” scheme of Destiny Health that is described in U.S. patent application Ser. No. 09/982,274, the contents of which are incorporated herein by reference. The present invention seeks to link the operation of a life insurance business to that of a medical scheme, by rewarding an insured life who is also a member of the related medical scheme for responsible use of the medical scheme benefits.

An example of the present invention will now be described with reference to the Vitality scheme of Destiny Health and an associated life insurance policy to be operated by Destiny Life. Accordingly, the method of the invention is applicable to Destiny Life policyholders who are also members of the Destiny Health medical scheme and the associated Vitality scheme. It will be appreciated that the described example is but one way of implementing the invention.

The insured life, who is also a member of the related medical scheme, pays premiums (typically monthly or annually) to the life insurance company determined by the value of a selected sum assured.

A payment will be made to the policyholder at the end of every 5 years, for example, during the term of the life insurance policy. Each 5 year period will be termed a “cycle”.

The payment can be made into an account that the insured life has with a financial institution, for example. Alternatively, the payment could be made into another vehicle, such as into a medical savings account that the insured life has with the medical scheme or into a credit or debit card of the insured life, which credit or debit card is associated with the life scheme or medical scheme.

At the end of each year, within each 5 year cycle, the life insurance company will accumulate a portion of the client's life insurance premiums into a fund, known as the “PayBack Fund”. The amount accumulated in the fund each year will depend on one or more of the following criteria:
1. The Destiny Health plan type chosen by the client (i.e. Comprehensive or Core plan)
2. The size of the family on the life scheme (i.e. principal only or family)
3. The level of claims made on the medical scheme by the policyholder (and family) over that year
4. The policyholder's Vitality status over that year (i.e. Blue, Bronze, Silver or Gold)
(The calculation of the portion of the policyholder's contributions to be accumulated into the PayBack Fund is set out in Tables 1 to 4 below.)

The amount accumulated in the PayBack Fund each year will not earn interest and any claims made by the policyholder against his/her life insurance policy will reduce the amount in the Payback Fund.

At the end of each five year cycle, the balance in the PayBack Fund will be paid out, and the hence the balance will start at zero at the beginning of every cycle. The calculation of the payback value in each cycle is completely independent of previous cycles so that no claims or premiums relating to previous cycles will be taken into account.

The premiums taken into account for the above described PayBack benefit will be the actual premiums paid by the client on his/her life policy. Premiums that are being waived will not be included in the PayBack benefit.

The invention essentially provides a method of rewarding clients for managing their health, the idea being that a person who looks after their health should pay less for their life assurance than a person who leads an unhealthy lifestyle.

Compared with existing methods that provide an upfront benefit to clients who manage their health by discounting their life policy premiums, the method of the present invention provides a long term benefit to clients who continue to look after their health by paying out a cash amount to them every five years.

The PayBack tables are dependent on the policyholder's Vitality status, annual medical scheme claims, medical scheme plan type and family size. Note that the claim bands differ between each table. The claim bands in the table will be adjusted each year to allow for inflation. For example, the PayBack tables could look as follows:

TABLE 1
Principal Only - Comprehensive Health Plan

| | Vitality Status | | | |
|---|---|---|---|---|
| Health Claim amounts | Blue | Bronze | Silver | Gold |
| 0 to 2200 | 20.00% | 25.00% | 35.00% | 50.00% |
| 2201 to 3800 | 15.00% | 20.00% | 30.00% | 45.00% |
| 3801 to 5400 | 10.00% | 15.00% | 25.00% | 40.00% |
| 5401 to 11000 | 7.50% | 12.50% | 22.50% | 37.50% |
| 11001 to 16300 | 2.50% | 7.50% | 17.50% | 32.50% |
| 16301 to 27000 | 0.00% | 5.00% | 15.00% | 30.00% |
| 27000+ | −2.50% | 2.50% | 12.50% | 27.50% |

TABLE 2
Family - Comprehensive Health Plan

| | Vitality Status | | | |
|---|---|---|---|---|
| Health Claim amounts | Blue | Bronze | Silver | Gold |
| 0 to 3250 | 20.00% | 25.00% | 35.00% | 50.00% |
| 3251 to 5400 | 15.00% | 20.00% | 30.00% | 45.00% |
| 5401 to 11000 | 10.00% | 15.00% | 25.00% | 40.00% |
| 11001 to 16300 | 7.50% | 12.50% | 22.50% | 37.50% |
| 16301 to 27000 | 2.50% | 7.50% | 17.50% | 32.50% |
| 27001 to 38000 | 0.00% | 5.00% | 15.00% | 30.00% |
| 38001+ | −2.50% | 2.50% | 12.50% | 27.50% |

TABLE 3
Principal Only - Core Health Plan

| | Vitality Status | | | |
|---|---|---|---|---|
| Health Claim amounts | Blue | Bronze | Silver | Gold |
| 0 to 1100 | 15.00% | 20.00% | 30.00% | 45.00% |
| 1101 to 2200 | 10.00% | 15.00% | 25.00% | 40.00% |
| 2201 to 3800 | 5.00% | 10.00% | 20.00% | 35.00% |
| 3801 to 5400 | 0.00% | 5.00% | 15.00% | 30.00% |
| 5401 to 11000 | −2.50% | 2.50% | 12.50% | 27.50% |
| 11001 to 16000 | −5.00% | 0.00% | 10.00% | 25.00% |
| 16001+ | −7.50% | −2.50% | 7.50% | 22.50% |

TABLE 4
Family - Core Health Plan

| | Vitality Status | | | |
|---|---|---|---|---|
| Health Claim amounts | Blue | Bronze | Silver | Gold |
| 0 to 1650 | 15.00% | 20.00% | 30.00% | 45.00% |
| 1651 to 3250 | 10.00% | 15.00% | 25.00% | 40.00% |
| 3251 to 6500 | 5.00% | 10.00% | 20.00% | 35.00% |
| 6501 to 11000 | 0.00% | 5.00% | 15.00% | 30.00% |
| 11001 to 16300 | −2.50% | 2.50% | 12.50% | 27.50% |
| 16301 to 27000 | −5.00% | 0.00% | 10.00% | 25.00% |
| 27000+ | −7.50% | −2.50% | 7.50% | 22.50% |

A example of a calculation basis that may be used is as follows:

$$Payback in Year 5 = Payback \% in Year 1 * Annual Life policy Premium for Year 1 + Payback \% in Year 2 * Annual Life policy Premium for Year 2 + Payback \% in Year 3 * Annual Life policy Premium for Year 3 + Payback \% in Year 4 * Annual Life policy Premium for Year 4 + Payback \% in Year 5 * Annual Life policy Premium for Year 5$$

−Claims made on life insurance policy over the 5 years

Calculation Example

An Integrated Policyholder is on the Comprehensive Destiny Health plan with a family size of
2. Both members on the plan have benefits with Destiny Life under the principal policy. The
policyholder makes no claims on his Life life insurance policy.

| | |
|---|---|
| Initial Annual Life policy Premium paid: | R 1 000 |
| Annual Destiny Life premium Increase: | 10% |
| Vitality Status Year 1: | Blue |
| Vitality Status Year 2: | Blue |
| Vitality Status Year 3: | Bronze |
| Vitality Status Year 4: | Silver |
| Vitality Status Year 5: | Gold |
| Total Medical Aid Claims Year 1: | R 2 000 |
| Total Medical Aid Claims Year 2: | R 4 000 |
| Total Medical Aid Claims Year 3: | R27 001 |
| Total Medical Aid Claims Year 4: | R 3 500 |
| Total Medical Aid Claims Year 5: | R 0 |
| Annual Life policy Premium (Year1) = R 1 000.00 | |
| Annual Life policy Premium (Year2) = R 1 100.00 (=R1 000 * (1 + 10%)) | |
| Annual Life policy Premium (Year3) = R 1 210.00 (=R1 100 * (1 + 10%)) | |
| Annual Life policy Premium (Year4) = R 1 331.00 (=R1 210 * (1 + 10%)) | |
| Annual Life policy Premium (Year5) = R 1 464.10 (=R1 331 * (1 + 10%)) | |
| From the above tables, allowing for the Vitality Status and Claims: | |
| Payback % (Year1) = 20% | |
| Payback % (Year2) = 15% | |
| Payback % (Year3) = 5% | |
| Payback % (Year4) = 30% | |
| Payback % (Year5) = 50% | |
| Hence: | |
| Payback in Year 5 = | R 1 000 * 20% + |
| | R 1 100 * 15% ++ |
| | R 1 210 * 5% ++ |
| | R 1 331 * 30% ++ |
| | R 1 464.10 * 50% = |
| | R 1 556.85 |

Note:
This example assumes that the claim bands in the PayBack table stay the same for the 5 year period.

1. A method of managing the business of a life insurance scheme of the kind in which a life insurer receives life insurance premiums from an insured life, the life insurer paying a predetermined sum assured to the insured life or a beneficiary nominated by the insured life on the occurrence of an insured event, the method comprising:
linking the life insurance scheme to a medical scheme of the kind in which the provider of such medical scheme undertakes liability in return for a premium or contribution, and provides to members who pay such premiums, or make such contributions, relevant health services and/or assistance in defraying expenses occurred in connection with rendering such relevant health services, the insured life being a member of the medical scheme;
allocating a portion of the life insurance premiums paid by the insured life during a predetermined period to a fund according to predetermined criteria related to the status of the insured life with the medical scheme during said predetermined period; and
at predetermined intervals, paying the balance in the fund to the insured life or a beneficiary nominated by the insured life.

2. A method according to claim 1 including deducting from the balance of the fund an amount related to life insurance claims made by the member during the predetermined period

3. A method according to claim 1 wherein the predetermined criteria in terms of which a portion of the premiums paid by the insured life are allocated to the fund include one or more of the following:
the specific medical plan chosen by the insured life;
the number of dependents of the insured life;
the level of claims made on the medical scheme by the insured life and his/her dependents during the predetermined period; and
the status of the insured life in a reward program associated with the medical plan.

4. A method according to claim 1 wherein the predetermined period is at least one year.

5. A method according to claim 4 wherein the predetermined period is a five-year period.

6. A method according to claim 1 wherein the allocation of a portion of the premiums paid to the fund is made annually.

7. A method according to claim 1 wherein the payment is made into an account that the insured life or nominated beneficiary has with a financial institution.

8. A method according to claim 1 wherein the payment is made into a medical savings account that the insured life has with the medical scheme or into a credit or debit card of the insured life, which credit or debit card is associated with the life insurance scheme or medical scheme.
